(19) United States
(12) Patent Application Publication
(10) Pub. No.: US 2007/0256075 A1
(43) Pub. Date: Nov. 1, 2007

(54) Method, system, and memory for scheduling and cancelling tasks

(75) Inventor: Martin Denis, Vaudreuil (CA)

Correspondence Address: Alex Nicolaescu;Ericsson Canada Inc., Patent Department, 8400 Decarie Blvd., Town Mount Royal, QC, H4P 2N2, CA

(73) Assignee: Telefonaktiebolaget L M Ericsson (publ)

(21) Appl. No.: 11/414,216

(22) Filed: May 1, 2006

(51) Int. Cl. G06F 9/46

(52) U.S. Cl. 718/102

(57) ABSTRACT

A memory, system and method for task scheduling and execution, the memory containing a data structure including a scheduling file containing tasks scheduled for execution, and a cancelling file containing references to tasks which execution is cancelled. A scheduler module reads the scheduled tasks of the scheduling file and the cancelled tasks of the cancelling file, and triggers execution of the scheduled tasks not referenced in the cancelling file. The data structure may comprise a plurality of pairs of scheduling and cancelling files, each pair being associated with a time interval. When the scheduler module receives from an application module a task scheduling request for scheduling a task, it writes the task in the task scheduling file. When the scheduler module further receives a task cancelling request for cancelling of the task, it writes the task in the task cancelling file.

### TECHNICAL FIELD

The present invention relates to the field of task scheduling for computer systems.

### BACKGROUND

Automated schedulers are used in various areas of the computer industry to ensure the execution of specific tasks (also called jobs), which may comprise the start of an application program, the execution of a script, the sending or processing of a message, or any other task performed with the help of a computer system. With such a scheduler, tasks are associated with specific execution dates and times (and sometimes also with specific conditions) so that they are executed at specific moments and in specific circumstances. Schedulers are used, for example, in Personal Computers (PCs), where operating systems like Microsoft Windows XP™ enable the user to schedule execution of particular software applications. Sometimes, applications themselves may be scheduled to start at given times. An example of a widely used scheduled application is the periodic start of an antivirus application, e.g. once a week, for scanning and removing electronic viruses from a PC.

The use of schedulers is becoming more and more common, particularly in computer-based systems that need to repetitively run complex tasks. Besides the PC environment, schedulers are nowadays used in many other areas, such as for example in telecommunication nodes where a multitude of tasks are scheduled based on the available processing resources, in the system management area where communications systems are regularly checked using monitoring applications, and even in the defense area where computers are scheduled to perform specific tasks such as radar control or satellite path reorientation.

Typically, a scheduler is used by a user to enter specific tasks that are to be executed at specific (future) dates and times, which are hereinafter referred to as the execution time for simplicity purposes. Based on the specified execution time, the scheduler creates instances (also called threads) with timers that are loaded into the computer system's memory. When a timer expires, the thread triggers the associated task, such as for example by starting an application or by executing the command specified in the task description.

However, an issue arises with these memory-implemented schedulers in systems that need to concomitantly schedule a significant number of tasks. This condition is exacerbated when such a significant number of tasks needs to be scheduled in the near future (e.g. few seconds to several weeks, or more). As the computer's memory is limited, the usage of multiple timers kept in the memory of the computer significantly limits the number of tasks that can be managed at once, besides slowing down the system's processing of other tasks.

Other schedulers utilities, for example, Cron supplied with the AIX operating system produced by IBM Corp., propose to solve the memory-implemented scheduled tasks limitations by using a task file which includes a list of tasks to be executed and the date/time or frequency for executing those tasks. Similarly, a partial solution to this problem has been proposed in the UK patent application number GB 2,355,319 assigned to IBM Corp, which discloses a job scheduler that makes use of a task file comprising one or more task definitions having associated conditions for executions. When the task file is changed, a program reads the task file and responsive to the conditions for executions of anyone on the tasks being met, triggers the execution of the task.

However, in instances where a significant number of tasks are being managed at substantially the same time, such as for example in telecommunication systems where thousands or millions of tasks can be scheduled for near-future execution, it was noticed that the user's access time to a task file written on a disk, added to the time needed to edit a task definition from the task file, and further to the time needed to write the changes to the file becomes too significant, and thus creates a limitative factor in the efficient use of task files for the purpose of task scheduling. Repeating the process for many tasks that are to be edited or deleted from the task file engenders significant delays, puts a heavy burden on the computer's processing resources, slows down the computer system operation and hampers the proper execution of the multiple tasks.

Accordingly, it should be readily appreciated that in order to overcome the deficiencies and shortcomings of the existing solutions, it would be advantageous to have a method and system for effectively managing scheduling of multiple tasks without affecting the computer system performances. The present invention provides such a method and system.

### SUMMARY

In one aspect, the present invention is a memory containing a scheduling data structure for storing scheduled tasks, the data structure comprising a scheduling file containing a plurality of tasks scheduled for execution, and a cancelling file containing a reference to at least one task of the plurality of tasks of the scheduling file which execution is to be cancelled.

In another aspect, the present invention is a scheduling system comprising a memory containing a scheduling data structure that includes i) a scheduling file containing a plurality of tasks scheduled for execution; and ii) a cancelling file containing a reference to at least one task of the plurality of tasks of the first scheduling file which execution is to be cancelled, the scheduling system further comprising a scheduler module in communication with the memory, the scheduler module being operative to read the plurality of tasks scheduled for execution of the scheduling file, to further read the reference to the at least one task of the cancelling file, and to trigger execution of the scheduled tasks of the scheduling file that are not referenced in the cancelling file.

In yet another aspect, the present invention is a method for task scheduling and execution comprising the steps of reading scheduled tasks from a task scheduling file, reading cancelled task from a task cancelling file, and triggering execution of scheduled tasks which are not also cancelled tasks.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level block diagram of a scheduling system implementing the preferred embodiment of the present invention;

FIG. 2 is an exemplary representation of a data structure of the scheduling system implementing the preferred embodiment of the present invention;

FIG. 3 is an exemplary representation of a portion of the data structure of the scheduling system implementing the preferred embodiment of the present invention;

FIG. 4 is another exemplary partial high-level block diagram of the scheduling system implementing the preferred embodiment of the present invention;

FIG. 5 is an exemplary flowchart diagram of a method for creating the data structure implementing the preferred embodiment of the invention;

FIG. 6 is an exemplary flowchart diagram of a method for scheduling a task according to the preferred embodiment of the invention;

FIG. 7 is an exemplary flowchart diagram of a method for canceling an already scheduled task according to the preferred embodiment of the invention; and

FIG. 8 is an exemplary flowchart diagram of a method for operating the scheduler system according to the preferred embodiment of the invention.

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a scheduling method and system which overcomes the deficiencies and shortcomings of the existing solutions by effectively managing the scheduling of multiple tasks without adversely affecting the computer system performances. According to the present invention, a scheduler is implemented using a scheduling data structure that may be saved in various types of memory, which is preferably a file system such as for example a hard disk drive. The scheduling data structure comprises at least one task scheduling file comprising multiple tasks scheduled for subsequent execution, i.e. for execution at a time later than the present time, and at least one task canceling file that comprises a subset of the multiple tasks, or reference thereto, which subsequent execution defined in the scheduling file is to be canceled. Therefore, a user (or a machine) can schedule a multitude of tasks for subsequent execution by saving these tasks in the scheduling file. Later, some of these tasks may need to be canceled and, with the present invention the tasks to be canceled or references thereto, need only to be appended at the end of the task canceling file, therefore removing the need for opening, editing (deletion and writing), and saving of the scheduling file, like in the existing prior art methods. This action of simply appending the cancelled tasks or their references to a file (i.e. the task canceling file) versus editing the task scheduling file which is typically significantly bigger in size, substantially shortens the time needed for the canceling action. With the present invention, the computer system only executes the scheduled tasks found in the scheduling file and not in the canceling file, since the tasks contained in the later are canceled from execution.

According to the present invention, the memory is preferably a file system such as for example a hard disk drive, although other implementations can also be contemplated. For example, the memory may be any kind of referenced memory, such as for example but not limited to a Random Access Memory (RAM), an optical disk such as a CD (Compact Disk) or a DVD (Digital Video Disk), and the likes. Furthermore, with the present invention the scheduling data structure may comprise a pair of a task scheduling file and a canceling file for predetermined time internals. For example, a pair of a scheduling and a canceling file can be defined for each e.g. 60 seconds time period, so that tasks scheduled for execution within the limits of the time period can be written into the scheduling file, while the tasks cancelled from execution within the same time interval can be written in the canceling file associated with that same time period. In this implementation, the scheduling data structure comprises a directory structure with multiple scheduling and canceling files, wherein a pair of one scheduling file and one canceling file are defined for each one of the consecutive time periods.

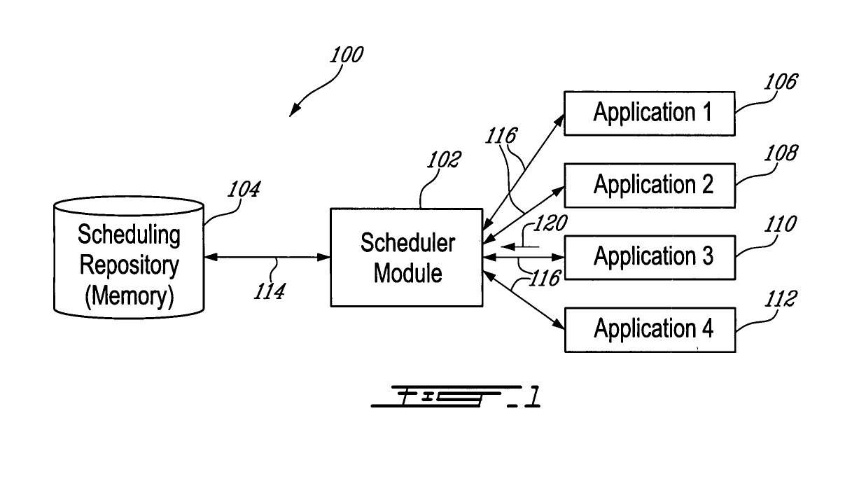

FIG. 1 is an exemplary high-level block diagram of a scheduling system 100 implementing the preferred embodiment of the present invention. Shown in FIG. 1 is the scheduling system 100 comprising a scheduler module 102 adapted to communicate via appropriate communication links 114 with a scheduling memory 104, such as for example a file system on a hard disk drive support, which stores a scheduling data structure with at least one task scheduling file and at least one task canceling file. The scheduler module 102 also communicates with one or more application modules 106-112, which are responsible for execution of specific actions in a computer system that implements the scheduling system 100. Such application modules may comprise well-known applications such as for example a virus scanning application 106, a message processing application 108, or any other kind of application. According to the invention, one (or more) of the applications 106-112 requests from the scheduler module 102 the scheduling of one or more tasks for subsequent execution. For this purpose, for example, the application 110 sends to the scheduler module 102 a scheduling request 120 comprising the task to be scheduled. The task request 120 may have various forms. For example, it may comprise a task identifier, a task description that may include the identity of the application to be started by the task, possibly one or more attributes, and the time (including the date) of the subsequent execution. Upon receipt of the task request 120, the scheduler module 102 writes the task in the scheduling memory 104, in the scheduling file associated with the indicated subsequent execution time.

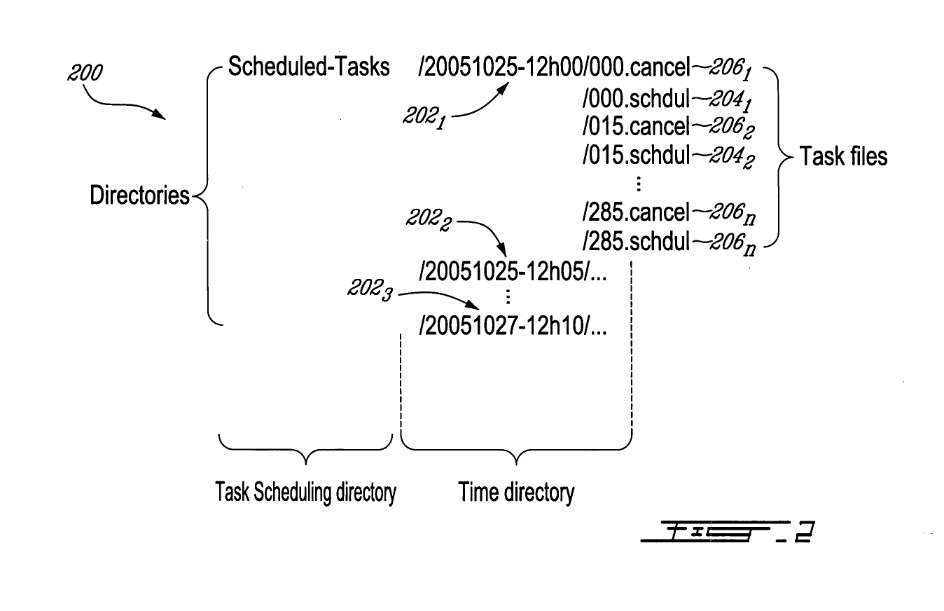

Reference is now made additionally to FIG. 2, which is a representation of an exemplary data structure 200 of the memory 104 of the scheduling system 100 implementing the preferred embodiment of the present invention. FIG. 2 shows the exemplary data structure 200 stored in the memory 104, which implements different directories for the storing of task scheduling files and task canceling files associated with different time periods. The data structure 200 comprises a plurality of directories 202, each one being associated with a given execution time interval. For example, the directory 202₁ is associated with the time period (interchangeably called herein time period and time interval) starting on Oct. 25, 2005, at 12:00 and ending on the same date at 12:05, while the directory 202₂ is associated with the time period starting on Oct. 25, 2005, at 12:05 (i.e. when the time associated with the directory 202₁, ends) and ending on the same date at 12:10, and comprising scheduling and canceling files analogous to the shown files 204 and 206. Thus, the data structure 200 comprises a plurality of directories 202 which store scheduling and canceling files that in combination cover extended periods of time. For example, the directory 202₁, stores multiple scheduling files 204 and multiple canceling files 206, wherein each pair of scheduling file 204ᵢ and canceling file 206ᵢ cover a given period of time, which in the present exemplary implementation is equivalent to 15 seconds. The scheduling file 204₂ identified as “015.schdul” comprises a list of tasks which are to be executed during the time internal starting on Oct. 25, 2005, at 12:00 plus 15 seconds (the “015” indicates the number of seconds after the time specified by the directory name when the task file should be read for executions of its tasks). The canceling file 206₂ identified as “015.cancel” comprises a list of tasks or references thereto which execution is to be canceled during the same time interval. Thus, in general, according to the present invention, the data structure may further comprises a plurality of pairs of one scheduling file and one cancelling file, wherein each pair is associated with a predetermined time interval in which limits are comprised execution times of tasks contained in that pair of one scheduling file and one cancelling file. Of course, alternatively, the data structure 200 may also comprise only one scheduling file and one cancelling file.

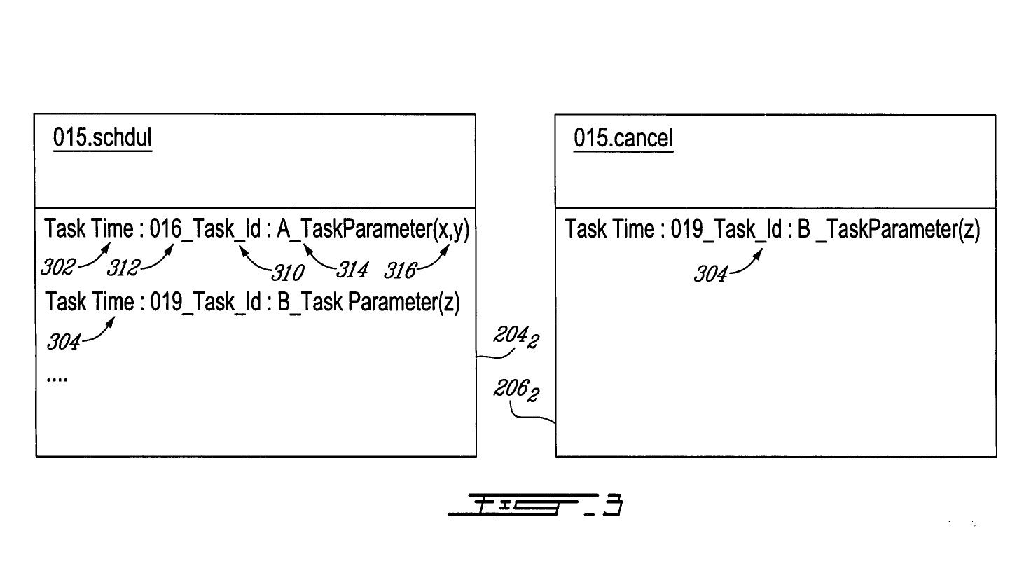

Reference is now additionally made to FIG. 3, which shows a portion of the data structure 200 of the scheduling system 100 implementing the preferred embodiment of the present invention. Shown in FIG. 2 are the scheduling file 204₂ “015.schdul” and the canceling file 206₂ “015.cancel”. The scheduling file 204₂ “015.schdul” comprises a plurality of tasks scheduled for later execution, such as for example the shown tasks 302 and 304. Each one of the tasks scheduled for execution, e.g. the task 302, comprises a task identifier 310 which comprises the identity of the task, an indication of the scheduled execution time 312 (which in the present implementation is provided by a number of seconds—16 seconds—that are to follow the time indicated by the task directory—i.e. 12:00—, but which in other implementations may comprise a fully identified date and time for execution), an indication A 314 of the application that is to be started by the task, and possibly one or more parameters 316 denoted by x, y, for use with the application A 314. In the present exemplary scenario, the canceling file 206₂ “015.cancel” comprises a reference 304 to the task to be cancelled, which may include the task itself, the identity 310 of the task, or any other indication of the task to be cancelled. When the reference comprises the task itself, the cancelled task may be identified in the canceling file 206₂ “015.cancel” just as it is in the associated scheduling file 204₂. Therefore, the scheduler system knows when reading both scheduling file 204₂ “015.schdul” and the canceling file 206₂ “015.cancel”, that although the task 304 is listed in the scheduling file, it should not be executed since it was canceled, as listed in the canceling file. For example, in the presently illustrated scenario of FIG. 3, provided that the scheduling file comprises tasks 302 and 304, and the canceling file comprises the task 304, as shown, it is only the task 304 that is executed (at its execution time) since it is the only task that appears in the scheduling file and not in the canceling file.

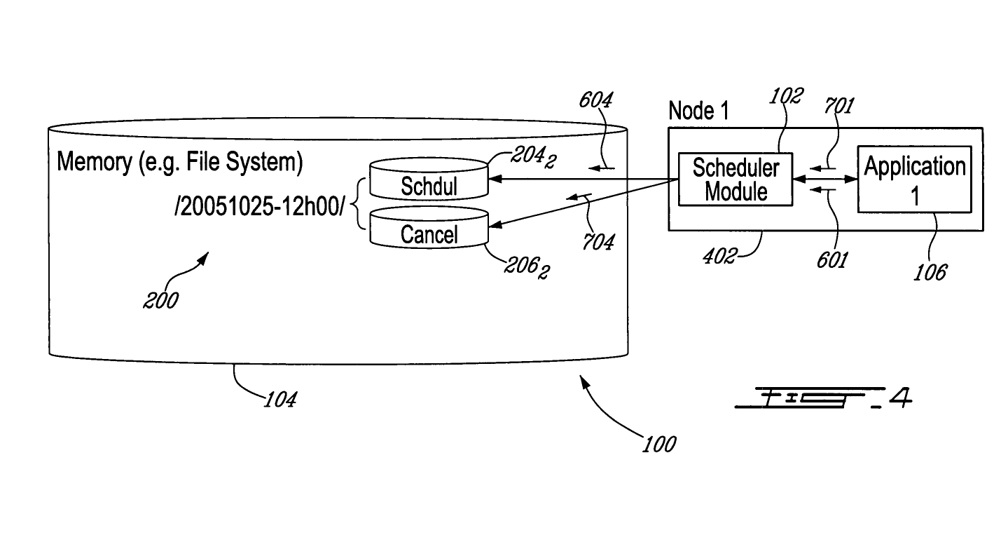

Reference is now made jointly to FIG. 4, which is another exemplary partial high-level block diagram of the scheduling system 100 implementing the preferred embodiment of the present invention, and to FIG. 5, which is an exemplary flowchart diagram of a method for creating the data structure implementing the preferred embodiment of the invention. FIG. 4 shows the scheduler module 100 with the scheduling memory 104 containing the data structure 200, and a communications node 402 that implements the scheduler module 102 and an application 106. The node 402 is connected via appropriate communications means to the memory 104. FIG. 4 shows only a portion of the data structure 200 for simplicity purposes. In action 502, the scheduler module 102 is started on a communication node 402, by for example launching the application associated with the scheduler. In action 504, the data structure 200 is created by the scheduler module 102, possibly based on the input of the user and, in action 506, the scheduler module 102 creates, within the data structure 200, the scheduling files and the canceling files, which for the time being, may be empty files, i.e. with no scheduled tasks inside. For example, as part of the action 506, the scheduler module 102 may create the portion of the data structure associated with the dates (e.g. a directory for each day alike/20051025/as shown), may further create another portion of the directory structure associate with the times, and may finally create multiple scheduling files and canceling files for the defined time intervals. Once the data structure 200 is created and the scheduling and canceling files are defined, the scheduler module 102 is ready for live operation, i.e. for the scheduling of tasks for execution, and eventually also for their canceling, if so required.

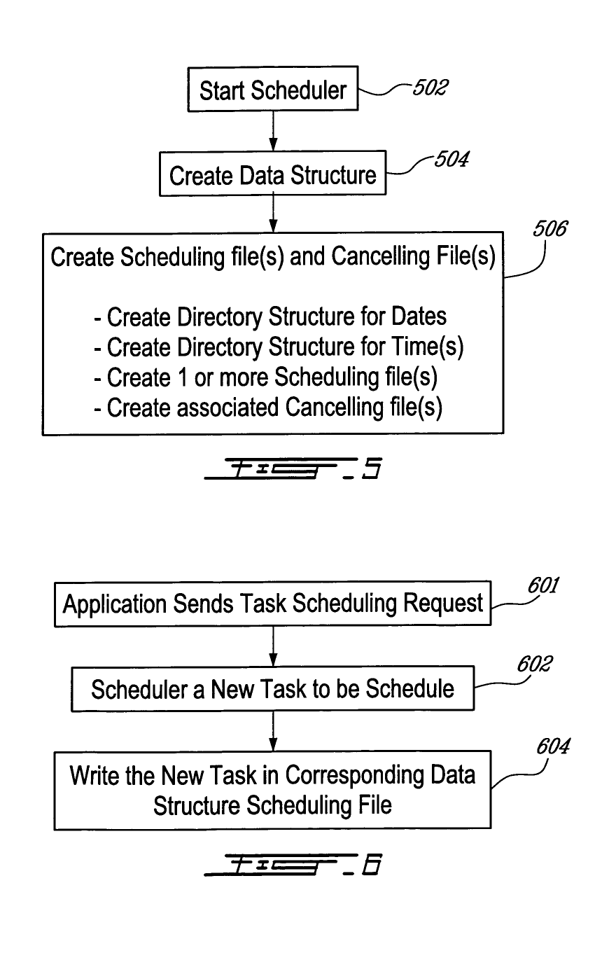

Reference is now further made jointly to FIG. 4, previously described, and to FIG. 6, which is an exemplary flowchart diagram of a method for scheduling a task according to the preferred embodiment of the invention. The application module 106 may have to schedule a task B for later execution, such as for example the starting of a script to perform some action, or the starting of a virus scan application that is to scan the computer system 402 for identifying and destroying electronic viruses. For this purpose, the application module 106 sends in action 601 a task scheduling request to the scheduler module 102, containing the task to be scheduled. The scheduler module 102 receives the task to be scheduled, action 602, and in action 604 writes (saves) the new task in their corresponding data structure scheduling file, which is deduced based on the time for execution of the task as indicated in the task description, that time being extracted by the scheduler module from the task scheduling request of action 601. With reference specifically being made to the exemplary scenario described in FIG. 4, it is assumed the task request of action 601 is for a task which is to scheduled for execution in the time interval covered by the scheduling file 204₂, and thus the scheduler module 102 writes the task in that file.

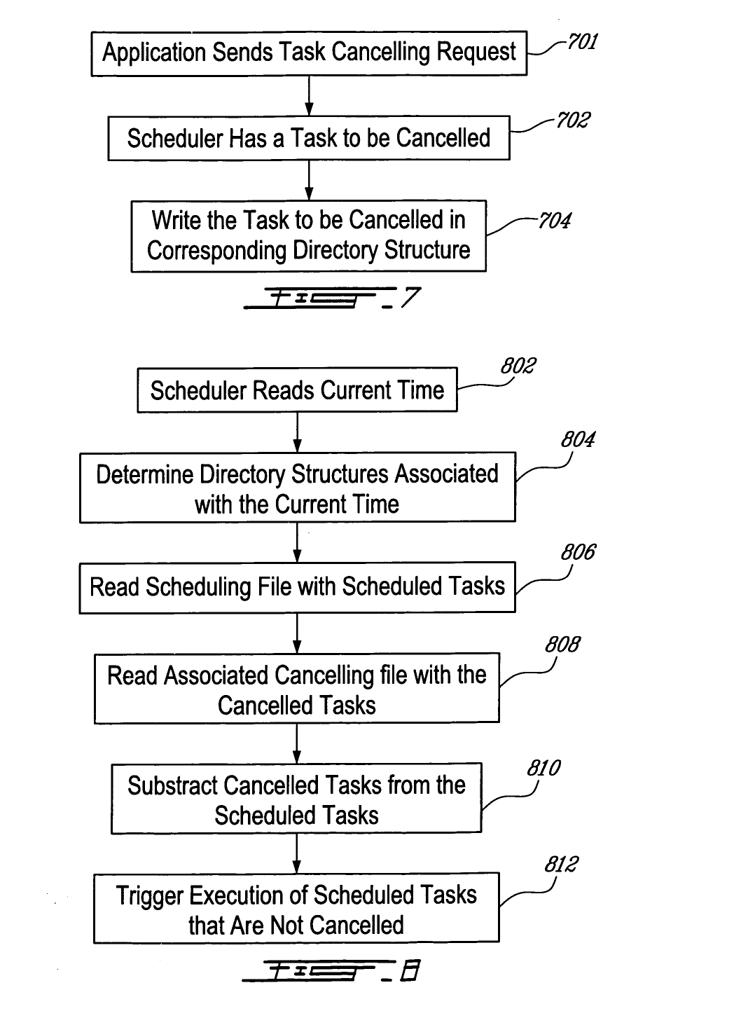

Reference is now further made jointly to FIG. 4, previously described, and to FIG. 7, which is an exemplary flowchart diagram of a method for canceling an already scheduled task according to the preferred embodiment of the invention. Once a task has been scheduled for subsequent execution as described in relation to FIG. 6, the circumstances that justified the scheduling of the task may change, and the scheduled task may need to be cancelled. For example, the user of the application 106 may determine that the task should no longer be executed at the subsequent time, or at all, and initiate the canceling of the task. For this purpose, in action 701 the application 106 issues a task canceling request which it sends to the scheduler module 106. The later receives the task canceling request and obtains the task to be cancelled, action 702. In action 704, the scheduler module 106 identifies in which canceling file the cancelled task is to be written based on the scheduled time of execution of the task, writes (saves) the cancelled task in the appropriate canceling file 206₂, which is associated with the time scheduled for the execution of the task. By writing the task also in the canceling file 206₂, the scheduler insures that the task will not be triggered (executed) at its scheduled time.

The actions described in relation to FIGS. 4, 6, and 7 can be repeated a significant number of times in systems where many tasks are to be scheduled in a given period of time, and wherein due to various circumstances and reasons, the execution of at least some of these tasks must be later cancelled. For example, in messaging systems like the cellular-based Multimedia Messaging System (MMS), thousands of messages are scheduled for subsequent processing and sending to the subscribers. Afterwards, some of these messages must be cancelled for various reasons. An exemplary situation occurs in MMS when the MMS Center schedules tasks for the periodical checking of a user terminal status, i.e. for periodically detecting whether or not the user terminal is ready to retrieve a pending MMS message stored in the MMS Center. When the terminal returns a message showing its readiness to receive the MMS message, the tasks scheduled in the MMS Center that are associated with the subsequent checks must be cancelled. Another exemplary situation where the present message may be advantageously utilized is also in the MMS center, wherein pending messages are set an expiry time period, that may be set, e.g. to 2 days. A task is therefore scheduled for deleting the message upon expiry of the 2 day time period. However, if the message is retrieved by the user terminal before the 2 day expiry, the scheduled task associated with the message deletion must be cancelled, since the message has been already retrieved. Such a system can be advantageously implemented using the present invention, wherein instead of i) re-opening the scheduling file that may contain a large number of scheduled tasks, ii) searching and identifying the right entry (task) to be cancelled or deleted, iii) deleting the entry, and then iv) closing and saving the file, as done in the prior art, with the present invention it is typically only a much smaller file—i.e. the canceling file containing only the tasks that are cancelled—which is opened, and the task to be cancelled is merely appended at the end of the file before saving the file. Therefore, with the present invention, the time needed to cancel a task is drastically shortened compared with the prior art methods, which, in the circumstances where this operation must be repeated a significant number of times for many tasks, considerably reduces the time needed for the operation.

Reference is now made jointly to FIG. 4, previously described and to FIG. 8, which is an exemplary flowchart diagram of a method for operating the scheduler system 100 according to the preferred embodiment of the invention. As tasks are scheduled for subsequent execution, and some cancelled, as defined in the data structure 200, the scheduler module 102 reads the current time, action 802. This action may be performed by the scheduler module 102 by reading the electronic time provided by the computer system 402. In action 804, as times goes by, the scheduler module 102 reads successively the scheduling and canceling files associated with the present time, i.e. which contain tasks scheduled for, or cancelled from, execution in the immediate future with respect to the present time. Thus, in action 804, the scheduler module 102 determines the directory and files associated with the current time. For example, if the current time read in action 802 is “Oct. 25, 2005, 12:00:14”, the scheduler module 102 determines based on the definition of the data structure 200 that it should read the directory identified /20051025-12h00/, and within that directory, to read the scheduling file 204₂ “015.schdul” and the canceling file 206₂ “015.cancel”, because these files contain the tasks which execution times immediately follow the present time. In action 806, the scheduler module 102 reads the tasks scheduled for execution comprised in the scheduling file 204₂ “015.schdul”, and in action 808 further reads the tasks that are canceled from execution as listed in the canceling file 206₂ “015.cancel”. Then, in action 810, the scheduler module 102 subtracts the canceled tasks read from the canceling file from the tasks read from the scheduling file, thus creating a list of tasks that are scheduled for execution and not canceled, which tasks are to be actually executed. Finally, in action 812, the scheduler module 102 triggers the execution of the tasks scheduled and not canceled. Action 812 may comprise communication between the scheduler module 102 and application modules described in the task descriptions and which are responsible for carrying out execution of the tasks.

Once the scheduler module 102 completes the execution of the tasks of a certain pair of scheduling and canceling files, it can delete these files from the data structure 200. Moreover, once the scheduler completes the execution of tasks of all pairs of scheduling files and canceling files form a given time directory, it can proceed to the deletion of such directory, thus freeing up data storage space from the memory 104.

Based upon the foregoing, it should now be apparent to those of ordinary skills in the art that the present invention provides an advantageous solution, which easy yet effective task scheduling and task canceling possibilities, which may be applied in various environments, including in environments where a large number of tasks are to be processed. Although the system and method of the present invention have been described in particular reference to several exemplary scenarios, it should be realized upon reference hereto that the innovative teachings contained herein are not necessarily limited thereto and may be implemented advantageously in various implementations not limited to the ones described herein. For example, with reference to FIG. 6, in action 602 the scheduler module 102 receives a new task to be scheduled. When the data structure 200 does not yet comprise a directory associated with the intended scheduling time of the task to be scheduled, i.e. the actions 504 and 506 of FIG. 5 did not yet created the directory associated with the intended scheduling time of the task, the scheduler module 102 may, in action 604 of FIG. 6, first create the appropriate directory and scheduling file associated with the intended execution time, and then write the task in the created data structure scheduling file. Such a circumstance may arise when the scheduler module 102 creates in actions 504 and 506 the data structure and scheduling files only for a certain period of time in advance, e.g. only for 3 days ahead, while receiving in action 603 a request for scheduling a task which intended execution time is even farther in the future, e.g. 5 days ahead. Furthermore, it is understood that the cancelled tasks identified in the canceling file described herein may be identified using various means, including but being not limited to the task itself or the simply the task identifier. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A memory containing a scheduling data structure for storing scheduled tasks, the data structure comprising:
a scheduling file containing a plurality of tasks scheduled for execution; and
a cancelling file containing a reference to at least one task of the plurality of tasks of the scheduling file which execution is to be cancelled.

2. The memory claimed in claim 1, wherein the reference to the least one task comprises the at least one task.

3. The memory as claimed in claim 2, wherein the scheduling file and the cancelling file contain tasks which are scheduled for execution and respectively cancelled from execution within a predetermined time interval.

4. The memory as claimed in claim 2, wherein the data structure further comprises a plurality of pairs of one scheduling file and one cancelling file, wherein each pair is associated with a predetermined time interval in which limits are comprised execution times of tasks contained in that pair of one scheduling file and one cancelling file.

5. The memory claimed in claim 2, wherein the memory comprises a file system on a hard disk drive support, the data structured being saved onto the file system.

6. A scheduling system comprising:
a memory containing a scheduling data structure that includes:
a scheduling file containing a plurality of tasks scheduled for execution; and
a cancelling file containing a reference to at least one task of the plurality of tasks of the first scheduling file which execution is to be cancelled; and
a scheduler module in communication with the memory, the scheduler module being operative to read the plurality of tasks scheduled for execution of the scheduling file, to further read the reference to the at least one task of the cancelling file, and to trigger execution of the scheduled tasks of the scheduling file that are not referenced in the cancelling file.

7. The scheduling system claimed in claim 6, wherein the reference to the least one task comprises the at least one task.

8. The scheduling system as claimed in claim 7, wherein the scheduling file and the cancelling file contain tasks which are scheduled for execution and respectively cancelled from execution within a predetermined time interval.

9. The scheduling system as claimed in claim 7, wherein the data structure further comprises a plurality of pairs of one scheduling file and one cancelling file, wherein each pair is associated with a predetermined time interval in which limits are comprised execution times of tasks contained in that pair of one scheduling file and one cancelling file.

10. The scheduling system claimed in claim 7, wherein the memory comprises a file system on a hard disk drive support, the data structured being saved onto the file system.

11. The scheduling system claimed in claim 7, wherein for triggering the execution, the scheduler module subtracts the at least one task read from the cancelling file from the plurality of tasks scheduled for execution read from the scheduling file.

12. The scheduling system claimed in claim 8, wherein the scheduler module reads a current time, and wherein the predetermined time interval immediately follows the current time.

13. The scheduling system claimed in claim 6, further comprising:
an application module operatively connected to the scheduler module, the scheduler module receiving from the application module a task scheduling request that requests the scheduling of a task and responsive to the receipt of the task scheduling request, the scheduler module writes the task in the task scheduling file, the scheduler module further receiving a task cancelling request requesting the cancelling of the task, and responsive to the task cancelling request writes the task in the task cancelling file.

14. The scheduling system claimed in claim 13, wherein the scheduler module extracts from the task scheduling request an execution time of the task and identifies based on the execution time the task scheduling file where the task is to be written, and also extracts from the task cancelling request an execution time of the task and identifies based on the execution time the task cancelling file where the task is to be written.

15. A method for task scheduling and execution comprising the steps of:
a. reading scheduled tasks from a task scheduling file;
b. reading cancelled task from a task cancelling file; and
c. triggering execution of scheduled tasks which are not also cancelled tasks.

16. The method claimed in claim 15, further comprising the step of:
d. prior to step c., subtracting the cancelled tasks from the scheduled tasks.

17. The method claimed in claim 15, wherein the task scheduling file and the task cancelling file contain tasks which are scheduled for execution and respectively cancelled from execution within a predetermined time interval, and the method further comprises the step of:
d. reading a current time;
wherein the predetermined time interval immediately follows the current time.

18. The method as claimed in claim 15, wherein the task scheduling file and the task cancelling file are comprised in a data structure that comprises a plurality of pairs of one scheduling file and one cancelling file, wherein each pair being associated with a predetermined time interval in which limits are comprised execution times of tasks contained in that pair of one scheduling file and one cancelling file.

19. The method claimed in claim 15, wherein the task scheduling file and the task cancelling file are saved in a file system on a hard disk drive support.

20. The method claimed in claim 15, further comprising prior to step a., the steps of:
d. creating a data structure comprising the task scheduling file and the task cancelling file;
e. receiving a task scheduling request that requests the scheduling of a task;
f. writing the task in the task scheduling file;
g. receiving a task cancelling request that requests the cancelling of the task; and
h. writing the task in the task cancelling file.

21. The method claimed in claim 20, wherein:
step f. comprises extracting from the task scheduling request an execution time of the task and identifying based on the execution time the task scheduling file where the task is to be written; and
step h. comprises extracting from the task cancelling request an execution time of the task and identifying based on the execution time the task cancelling file where the task is to be written.
